(19) United States
(12) Patent Application Publication
(10) Pub. No.: US 2014/0300906 A1
(43) Pub. Date: Oct. 9, 2014

(54) LASER SCANNER WITH CELLULAR TRANSCEIVER COMMUNICATION

(71) Applicant: FARO Technologies, Inc., Lake Mary, FL (US)

(72) Inventors: Reinhard Becker, Ludwigsburg (DE); Martin Ossig, Tamm (DE); Andreas Ditte, Ludwigsburg (DE)

(73) Assignee: FARO Technologies, Inc., Lake Mary, FL (US)

(21) Appl. No.: 14/205,436

(22) Filed: Mar. 12, 2014

Related U.S. Application Data
(60) Provisional application No. 61/786,938, filed on Mar. 15, 2013.

(30) Foreign Application Priority Data
Mar. 13, 2013 (DE) 102013102554.4

(51) Int. Cl. G01B 11/00

(52) U.S. Cl. CPC G01B 11/005
USPC 356/614

(57) ABSTRACT

A laser scanner that measures three-dimensional (3D) coordinates of a point by steering a beam of light to the point and receiving reflected light with a distance meter, the laser scanner further including a cellular transceiver component for exchanging scanner data and scanner instructions through a cellular network.

### CROSS REFERENCE TO RELATED APPLICATIONS

The present application claims the benefit of U.S. Provisional Patent Application No. 61/786,938, filed Mar. 15, 2013, and of German Patent Application No. DE102013102554.4, filed Mar. 13, 2013, both of which are hereby incorporated by reference.

### BACKGROUND OF THE INVENTION

The subject matter disclosed herein relates to the use of a cellular transceiver to transmit data to and receive data from a network by a three-dimensional (3D) coordinate measurement device such as a scanner, tracker, or total station that measures two angles and one distance, the one distance being an absolute distance based on a time-of-flight measurement. Such measurement devices may be located where access is not available to wired (e.g., Ethernet) signals or short-range wireless (e.g., IEEE 802.11 Wi-Fi) signals.

Examples of environments in which scanners, trackers, and total stations may be used but may not provide access to wired network connections or routers includes construction sites, forensics sites, and archaeological sites.

Accordingly, while existing 3D coordinate measurement devices are suitable for their intended purposes, what is needed is a 3D coordinate measurement device having certain features of embodiments of the present invention.

### BRIEF DESCRIPTION OF THE INVENTION

According to one aspect of the invention, a device is provided for optical scanning and measuring of an environment, the device having a device frame of reference, the device includes a light transmitter that sends a transmission light beam to a first point in the environment; a first motor and a second motor that together direct the transmission light beam to a first direction, the first direction determined by a first angle of rotation about a first axis and a second angle of rotation about a second axis, the first angle of rotation produced by the first motor and the second angle of rotation produced by the second motor; a first angle measuring unit that measures the first angle of rotation and a second angle measuring unit that measures the second angle of rotation; a distance meter that receives a reception light beam and converts the reception light beam into a first electrical signal, the reception light beam being a portion of the transmission light beam reflected or scattered from the first point; a processor configured to determine a first distance based at least in part on the first electrical signal and a speed of light in air, the first distance being a distance from the device to the first point, the processor further configured to determine three-dimensional (3D) coordinates of the first point in the device frame of reference, the 3D coordinates of the first point based at least in part on the first distance, the first angle of rotation, and the second angle of rotation; and a cellular transceiver configured to send data to and receive data from a cellular network, the cellular transceiver including an antenna, the cellular network being a wireless network distributed over land area cells, each cell being served by a least one fixed-location base-station transceiver, each cell using a set of frequencies different than the frequencies used by neighboring cells.

According to another aspect of the invention, a method is provided for optical scanning and measuring of an environment with a device, the method including steps of providing the device having a device frame of reference, the device including a light transmitter, a first motor, a second motor, a first angle measuring unit, a second angle measuring unit, a distance meter, a processor, and a cellular transceiver, the cellular transceiver configured to send data to and receive data from a cellular network, the cellular transceiver including an antenna, the cellular network being a wireless network distributed over land area cells, each cell being served by at least one fixed-location base-station transceiver, each cell using a set of frequencies different than frequencies used by neighboring cells; sending a transmission light beam from the light transmitter to a first point in the environment; directing, with the first motor and the second motor, the transmission light beam to a first direction, the first direction determined by a first angle of rotation about a first axis and a second angle of rotation about a second axis, the first angle of rotation produced by the first motor and the second angle of rotation produced by the second motor; measuring the first angle of rotation with the first angle measuring device and the second angle of rotation with the second angle measuring device; receiving a reception light beam with the distance meter, the reception light beam being a portion of the transmission light beam reflected or scattered from the first point; converting with the distance meter the reception light beam into a first electrical signal; determining with the processor a first distance, the first distance based at least in part on the first electrical signal and a speed of light in air, the first distance being a distance from the device to the first point; further determining with the processor three-dimensional (3D) coordinates of the first point in the device frame of reference, the 3D coordinates of the first point based at least in part on the first distance, the first angle of rotation, and the second angle of rotation; and sending or receiving data through the cellular network with the cellular transceiver.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a laser scanner in accordance with an embodiment of the invention;

FIG. 2 is a side view of the laser scanner of FIG. 1 illustrating the method of measurement; and

FIG. 3 is a schematic illustration of the optical, mechanical, and electrical components of the laser scanner of FIG. 1.

### DETAILED DESCRIPTION OF THE INVENTION

Embodiments of the present invention relate to a 3D coordinate measurement device that steers a beam of light to a target, which may be a cooperative target such as a retroreflector or a non-cooperative target such as a diffusely scattering surface of an object. A distance meter in the device measures a distance to the object, and angular encoders measure the angles of rotation of two axles in the device. The measured distance and two angles enable a processor 38 in the device to determine the 3D coordinates of the target.

Embodiments of the present invention disclosed herein relate to a laser scanner, but the extension to embodiments involving a laser tracker or a total station will be clear to one of ordinary skill in the art. Laser scanners are typically used for scanning closed or open spaces such as interior areas of buildings, industrial installations and tunnels. Laser scanners are used for many purposes, including building information modeling (BIM), industrial analysis, accident reconstruction applications, archaeological studies, and forensics investigations. A laser scanner can be used to optically scan and measure objects in a volume around the scanner through the acquisition of data points representing objects within the volume. Such data points are obtained by transmitting a beam of light onto the objects and collecting the reflected or scattered light to determine the distance, two-angles (i.e., an azimuth angle and a zenith angle), and optionally a gray-scale value. This raw scan data is collected, stored and sent to a processor or processors to generate a three-dimensional image representing the scanned area or object. In order to generate the image, at least three values are collected for each data point. These three values may include the distance and two angles, or may be transformed values, such as x, y, z coordinates.

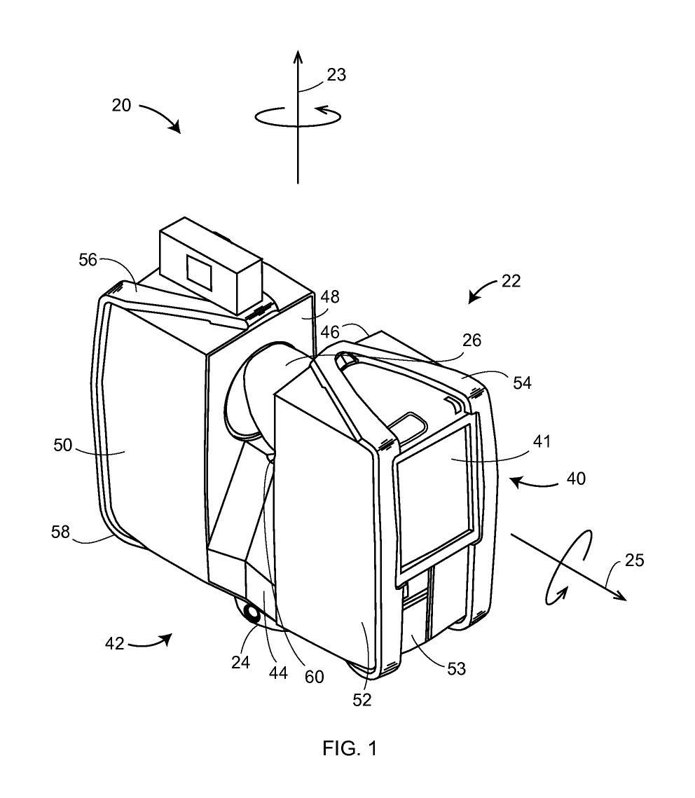

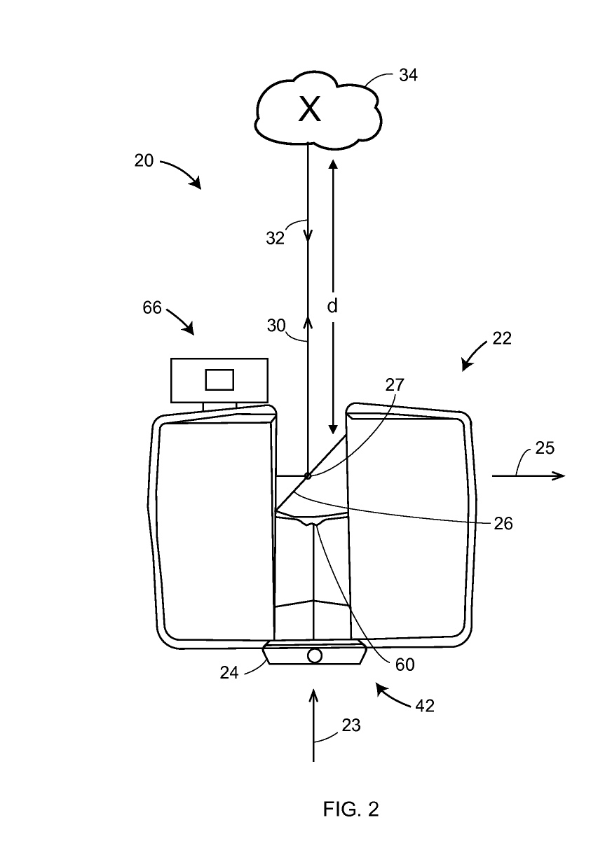

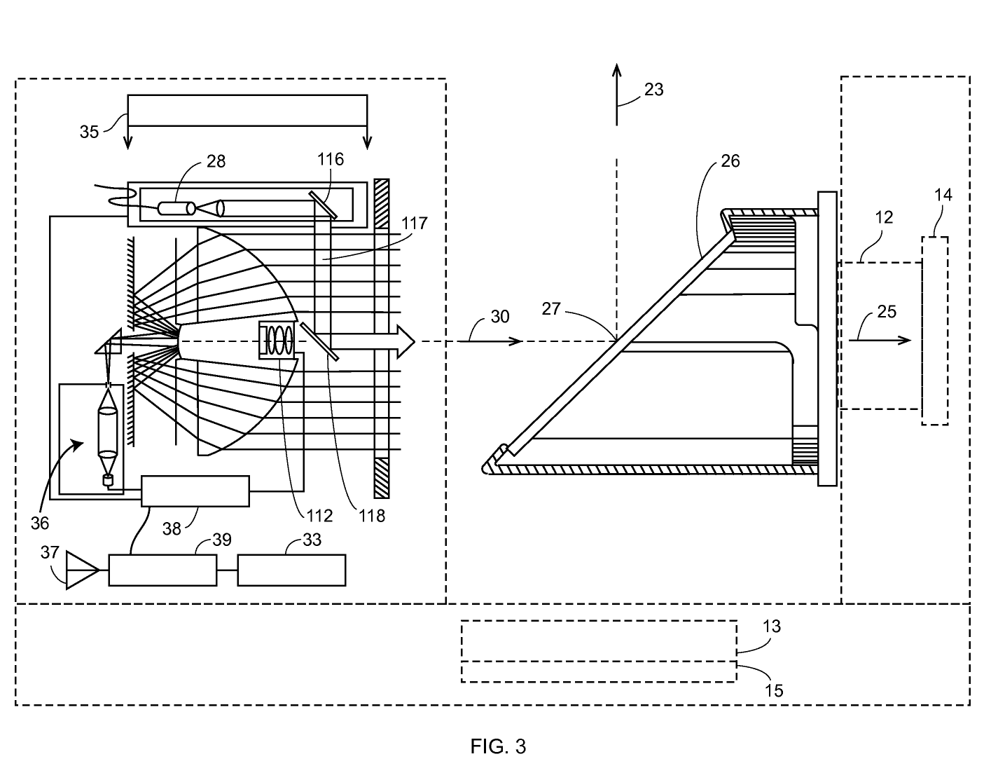

Referring now to FIGS. 1-3, a laser scanner 20 is shown for optically scanning and measuring the environment surrounding the laser scanner 20. The laser scanner 20 has a measuring head 22 and a base 24. The measuring head 22 is mounted on the base 24 such that the laser scanner 20 may be rotated by a motor 13 about a vertical axis 23. In one embodiment, the measuring head 22 includes a gimbal point 27 that is a center of rotation about a vertical axis 23 and a horizontal axis 25. The measuring head 22 has a rotary mirror 26, which may be rotated by a motor 12 about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 may be amplitude or intensity modulated, for example, with a sinusoidal waveform or with a rectangular waveform. Alternatively, the emitted light beam 30 may be otherwise modulated, for example, with a chirp signal, or coherent receiver methods may be used. The emitted light beam 30 is emitted by the light emitter 28 onto the rotary mirror 26, where it is deflected to the environment. A reflected light beam 32 is reflected from the environment by an object 34. The reflected or scattered light is intercepted by the rotary mirror 26 and directed onto a distance meter 36. The directions of the emitted light beam 30 and the reflected light beam 32 result from the angular positions of the rotary mirror 26 and the measuring head 22 about the axis 25 and 23, respectively. These angular positions in turn depend on the corresponding rotary drives. The angle of rotation about the horizontal axis 25 is measured by an angular encoder 14. The angle of rotation about the vertical axis 23 is measured by an angular encoder 15.

Coupled to the light emitter 28 and the distance meter 36 is a processor 38. The processor 38 determines, for a multitude of measuring points X, a corresponding number of distances d between the laser scanner 20 and points X on object 34. The distance to a particular point X is determined based at least in part on the speed of light in air through which electromagnetic radiation propagates from the device to the object point X. In one embodiment the phase shift in the modulated light beam 30, 32 sent to the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight of the light in the air (the round-trip time for the light to travel from the device to the object and back to the device). A method of measuring distance based on the time-of-flight of light (or any type of electromagnetic radiation) depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based one known length and two known angles of a triangle. The method of triangulation, therefore, does not directly depend on the speed of light in air.

In an embodiment, the scanning of the volume about the laser scanner 20 takes place by rotating the rotary mirror 26 relatively quickly about horizontal axis 25 while rotating the measuring head 22 relatively slowly about vertical axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power. The gray-scale value may be determined, for example, by integration of the bandpass-filtered and amplified signal in the distance meter 36 over a measuring period attributed to the object point X.

The measuring head 22 may include a display device 40 integrated into the laser scanner 20. The display device 40 includes a user interface, which may be a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20. In an embodiment, a prism retroreflector 60 is located on the traverse to provide a means of compensating the scanner over time.

On an end of the shells 50, 52 opposite the walls 46, 48, a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion for each yoke 54, 56 extends from the traverse 44 obliquely to an outer corner of the respective shell 50, 54. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54 and the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

The base 24 is coupled to a swivel assembly (not shown) such as that described in commonly owned PCT Application Serial No. PCT/EP2011/003263, which is incorporated herein in its entirety. The swivel assembly is housed within the carrying structure 42 and includes a motor 13 that is configured to rotate the measuring head 22 about the axis 23.

A second image acquisition device 66 may be a device that captures and measures a parameter associated with the scanned volume or the scanned object and provides a signal representing the measured parameters over an image acquisition area. Therefore, the second image acquisition device 66 may be, but is not limited to, a pyrometer, a thermal imager, an ionizing radiation detector, or a millimeter-wave detector.

In an embodiment, a camera (first image acquisition device) 112 is located internally to the scanner and may have the same optical axis as the 3D scanner device. In this embodiment, the image acquisition device 112 is integrated into the measuring head 22 and arranged to acquire images along the same optical pathway as emitted light beam 30 and reflected light beam 32. In this embodiment, the light emitter 28 is reflected off a fixed mirror 116, travels to dichroic beam-splitter 118 that reflects the light 117 from the light emitter 28 onto the rotary mirror 26. The dichroic beam-splitter 118 allows light at wavelengths different than the wavelength of light 117 to pass through. For example, the light emitter 28 may be a near infrared laser light (for example, light at wavelengths of 780 nm or 1150 nm), with the dichroic beam-splitter 118 configured to reflect the infrared laser light while allowing visible light (e.g. wavelengths of 400 to 700 nm) to transmit through. In other embodiments, the determination of whether the light passes through the beam-splitter 118 or is reflected depends on the polarization of the light. The digital camera 112 takes 2D photographic images of the scanned area in order to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

In an embodiment, the laser scanner 20 includes a battery 35 that may be used to power the scanner, thereby making it usable in the absence of electrical power from power mains. In an embodiment, the battery is a rechargeable Li-Ion battery capable of powering the scanner for five hours before recharging. A battery has advantages for use in out-of-the-way locations for applications such as surveying, construction, archaeological, and accident reconstruction sites.

In many cases, it is highly desirable to set up the scanner quickly using a minimum of equipment and expending a minimum of operator time. Acting against this desirable outcome is the need usually found in practice to connect a laptop computer to the scanner to store the large amount of data received from the scanner. This is necessary because, in out-of-the-way locations, it is usually not possible to connect to a network or to the Internet (a network of networks) through a direct wired connection such as Ethernet or through a router that provides wireless network access, for example by means of IEEE 802.11 (Wi-Fi). In out-of-the-way locations, it is often the case that network connections do not exist. In other cases, network connections exist, but the scanner operator does not have authorization to tap into such networks. Similarly, unless such a wired network is available nearby, access will not be available to a router that can provide close-range wireless connectivity, for example through IEEE 802.11.

A way around this limitation in network access is to obtain a network connection through cellular towers, which are widespread throughout most of the inhabited world. A cellular network is a wireless network distributed over land area call cells. Each cell is served by a least one fixed-location base station transceiver. Each cell uses a different set of frequencies from neighboring cells to avoid interference and provide guaranteed bandwidth. When joined together, the cells provide radio coverage over a wide geographic area. The later generations of cellular networks, in particular, provide the capability for transferring large amounts of scanner data. Fourth generation (4G) cellular networks may support LTE (Long Term Evolution) or LTE Advanced standards, which are designed to carry data at relatively high rates in uplink and downlink modes. Fifth generation (5G) cellular networks are currently under development.

Of particular interest is the transfer of data to the Cloud, where the Cloud refers to the Internet but especially to a data center full of servers connected to the Internet. Data may be sent from the scanner to the Cloud, which may store and process the scanner data and provide the processed results to an authorized user.

A way to enable a scanner to upload or download data over a cellular network is to provide a cellular transceiver 39, which is attached to an antenna 37. By providing a relatively large omnidirectional antenna 37 in combination with a cellular transceiver having a high gain built-in amplifier, it is possible in many cases to get obtain LTE uplink and download transfer speeds substantially faster than available with a cell phone. The cellular transceiver 39 is integrated into the scanner and hence has a location fixed in relation to the gimbal point 27.

In one mode of operation, the operator controls the scanner through the display device 40 and graphical touch screen 41 shown in FIG. 1. In this mode of operation, a certain amount of scan data may be stored on mass memory built into the scanner. For example, the scanner may include an SD memory card having a memory capacity of 4 GB or greater. Such an SD card may be placed in a card slot 53 shown in FIG. 1. In this case, the stored scan data would be processed in a later step, most likely off the job site.

In another mode of operation, the operator controls the scanner through a computing device such as a laptop computer. Data may be stored on the laptop computer and processed on or off the job site.

In another mode of operation, the operator gains access to a network through the cellular transceiver 39 in the scanner. In an embodiment, the cellular transceiver is an LTE (or LTE Advanced) transceiver. The scanner may immediately transfer scanner data to the Cloud for storage and processing. Use of the transceiver in this way reduces required equipment and speeds operation. The operator ordinarily gains access to a network by means of instructions provided by the processor 38 to the operator through the graphical user interface 41. The operator interacts with the user interface to carry out a series of steps that connects the laser scanner through the cellular network to a server, the connection ordinarily being made over an internet communication channel.

In another mode of operation, the LTE transceiver 39 is connected to a wireless router 33 that acts as a mobile Wi-Fi hotspot. Such a hotspot permits the operator to use a mobile phone or other smart device to wirelessly control the scanner or receive data from the scanner over IEEE 802.11 (Wi-Fi). The operator may also communicate with the scanner by direct short-range communications protocols such as Bluetooth.

In another mode of operation, the operator connects to a cellular network, for example over LTE, by means of a cell phone or other smart device. The scanner also connects to the cellular network. The operator may then control the scanner and view results obtained by the scanner, all scanning results uploaded and downloaded through the cellular network. The network may receive and transfer analyses, pictures, and other data generated by the scanner. In most cases, a security protocol is put in place to ensure security of collected data.

In a preferred embodiment for a forensics investigation, the laser scanner 10 is activated at the site of crime. The processor 38 determines the 3D coordinates of the points X of an object and transfers the measured points X (i.e., the scanned points) to a network through the cellular transceiver 39. Such a network transfer is possible, even in a typical crime scene in which a network connection is not available through a computer or router. A police computer logs onto the network, either remotely or from the crime scene, thereby enabling an investigator to evaluate the scan and to provide instructions for further processing. If necessary, a remote investigator may send control statements directly to the laser scanner 10 or to the operators at the site of crime, for example, when the position of the laser scanner 10 is to be changed.

In other cases, a remote observer may remotely view scan data on the Cloud and send scanning instructions to operators. In other cases, a remote observer may send commands to control the behavior of the scanner. For example, the remote observer may send the scanner instructions to complete a scan (at a fixed location) every two hours.

The cellular network may also serve to connect several scans or to register them together. For example, several scans may be taken of a scene, of various rooms of a building, or of the same environment at different times. The network may serve as an “assistant” of the scanning process to provide an indication of scanning progress. In an embodiment, each of the scanners is connected to Cloud through the cellular network.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A device for optical scanning and measuring of an environment, the device having a device frame of reference, the device comprising:
a light transmitter that sends a transmission light beam to a first point in the environment;
a first motor and a second motor that together direct the transmission light beam to a first direction, the first direction determined by a first angle of rotation about a first axis and a second angle of rotation about a second axis, the first angle of rotation produced by the first motor and the second angle of rotation produced by the second motor, the first axis and the second axis intersecting in a gimbal point;
a first angle measuring unit that measures the first angle of rotation and a second angle measuring unit that measures the second angle of rotation;
a distance meter that receives a reception light beam and converts the reception light beam into a first electrical signal, the reception light beam being a portion of the transmission light beam reflected or scattered from the first point;
a processor configured to determine a first distance based at least in part on the first electrical signal and a speed of light in air, the first distance being a distance from the device to the first point, the processor further configured to determine three-dimensional (3D) coordinates of the first point in the device frame of reference, the 3D coordinates of the first point based at least in part on the first distance, the first angle of rotation, and the second angle of rotation; and
a cellular transceiver configured to send data to and receive data from a cellular network, the cellular transceiver including an antenna, the cellular network being a wireless network distributed over land area cells, each cell being served by a least one fixed-location base-station transceiver, each cell using a set of frequencies different than the frequencies used by neighboring cells, the cellular transceiver being integrated into the device and having a fixed location relative to the gimbal point.

2. The device of claim 1, wherein the cellular transceiver is further configured to operate in conformance with a Long Term Evolution (LTE) standard or LTE Advanced standard.

3. The device of claim 1 further including computer readable media having computer readable instructions which when executed by the processor enables an operator by means of one or more actions to connect the device through the cellular network to a server, the connection being made over an internet communication channel.

4. The device of claim 3 further comprising a display unit, the display unit including a user interface through which the operator carries out the one or more actions.

5. The device of claim 4 further comprising a battery that provides electrical power to the device, the electrical power being all electrical power required for full functionality of the device in the absence of electrical power supplied from power mains.

6. The device of claim 3 wherein the processor is further configured to receive and carry out instructions from a remote observer, the remote observer sending the instructions from the server over the internet communication channel.

7. The device of claim 1 further comprising a wireless router in communication with the cellular transceiver, the wireless router configured to act as a hotspot according to the IEEE 802.11 (Wi-Fi) standard, the wireless router configured to enable communication between the device and a component capable of wireless Wi-Fi communication.

8. A method of optical scanning and measuring of an environment with a device, the method comprising steps of:
providing the device having a device frame of reference, the device including a light transmitter, a first motor, a second motor, a first angle measuring unit, a second angle measuring unit, a distance meter, a processor, and a cellular transceiver, the cellular transceiver configured to send data to and receive data from a cellular network, the cellular transceiver including an antenna, the cellular network being a wireless network distributed over land area cells, each cell being served by at least one fixed-location base-station transceiver, each cell using a set of frequencies different than frequencies used by neighboring cells;
sending a transmission light beam from the light transmitter to a first point in the environment;
directing, with the first motor and the second motor, the transmission light beam to a first direction, the first direction determined by a first angle of rotation about a first axis and a second angle of rotation about a second axis, the first angle of rotation produced by the first motor and the second angle of rotation produced by the second motor, wherein the first axis and the second axis intersect in a gimbal point and the cellular transceiver is integrated into the device and has a fixed location relative to the gimbal point;
measuring the first angle of rotation with the first angle measuring device and the second angle of rotation with the second angle measuring device;
receiving a reception light beam with the distance meter, the reception light beam being a portion of the transmission light beam reflected or scattered from the first point;
converting with the distance meter the reception light beam into a first electrical signal;
determining with the processor a first distance, the first distance based at least in part on the first electrical signal and a speed of light in air, the first distance being a distance from the device to the first point;
further determining with the processor three-dimensional (3D) coordinates of the first point in the device frame of reference, the 3D coordinates of the first point based at least in part on the first distance, the first angle of rotation, and the second angle of rotation; and
sending or receiving data through the cellular network with the cellular transceiver.

9. The method of claim 8, wherein:
in the step of providing a device, the cellular transceiver is further configured to operate in conformance with a Long Term Evolution (LTE) standard or LTE Advanced standard; and
in the step of sending or receiving data through the cellular network, the data is sent or received in conformance with an LTE standard or an LTE Advanced standard.

10. The method of the device of claim 8 wherein the step of providing a device further includes providing computer readable media having computer readable instructions which when executed by the processor enables an operator by means of one or more actions to connect the device through the cellular network to a server, the connection being made over an internet communication channel.

11. The method of claim 10 further including performing by the operator one or more actions to connect the device through the cellular network to a server.

12. The method of claim 11 wherein the operator carries out one or actions on a display unit, the display unit being an integral part of the device, the display unit including a user interface through which the operator carries out the one or more actions.

13. The method of claim 12 wherein in the step of providing a device, the device further includes a battery that provides electrical power to the device, the electrical power being to provide full functionality for the device in the absence of electrical power supplied from power mains.

14. The method of claim 10 further including:
sending, by a remote observer, instructions from the server, the instructions being sent over the internet communication channel; and
receiving and carrying out the instructions from the remote observer by the processor.

15. The method of claim 8 wherein the step of providing a device further includes providing a wireless router in communication with the cellular transceiver, the wireless router configured to act as a hotspot according to the IEEE 802.11 (Wi-Fi) standard, the wireless router configured to enable communication between the device and a component capable of wireless Wi-Fi communication.

16. The method of claim 15 further including a step of the communicating with the device, the communicating carried out by the operator through the wireless router, the communication carried out over IEEE 802.11.
